(19) United States
(12) Patent Application Publication
(10) Pub. No.: US 2013/0246967 A1
(43) Pub. Date: Sep. 19, 2013

(54) Head-Tracked User Interaction with Graphical Interface

(71) Applicants: Aaron Joseph Wheeler, San Francisco, CA (US); Luis Ricardo Prada Gomez, Hayward, CA (US); Liang-Yu Tom Chi, San Francisco, CA (US); Alejandro Kauffman, San Francisco, CA (US)

(72) Inventors: Aaron Joseph Wheeler, San Francisco, CA (US); Luis Ricardo Prada Gomez, Hayward, CA (US); Liang-Yu Tom Chi, San Francisco, CA (US); Alejandro Kauffman, San Francisco, CA (US)

(73) Assignee: Google Inc., Mountain View, CA (US)

(21) Appl. No.: 13/421,760

(22) Filed: Mar. 15, 2012

(51) Int. Cl. G06F 3/048; G06F 3/033

(52) U.S. Cl. 715/784

(57) ABSTRACT

A computer-implemented method includes controlling a wearable computing device (WCD) to provide a user-interface that has one or more menu items and a view region. The method also includes receiving movement data corresponding to movement of the WCD from a first position to a second position and, responsive to the movement data, controlling the WCD such that the one or more menu items are viewable in the view region. Further, the method includes, while the one or more menu items are viewable in the view region, receiving selection data corresponding to a selection of a menu item and, responsive to the selection data, controlling the WCD to maintain the selected menu item substantially fully viewable in the view region and in a substantially fixed position in the view region that is substantially independent of further movement of the WCD.

### BACKGROUND

Computing devices such as personal computers, laptop computers, tablet computers, cellular phones, body-mountable or wearable computing devices, and other types of devices are increasingly prevalent in numerous aspects of modern life. Generally, a computing device can be configured to display or otherwise provide information to a user and to facilitate user interaction with the provided information and the computing device.

### SUMMARY

In a first aspect, a computer-implemented method includes controlling a wearable computing device to provide a user-interface that has (i) one or more menu items and (ii) a view region that defines an area in which the one or more menu items are selectively viewable. The method also includes receiving movement data corresponding to movement of the wearable computing device from a first position to a second position and, responsive to the movement data, controlling the wearable computing device such that the one or more menu items are viewable in the view region. Further, the method includes, while the one or more menu items are viewable in the view region, receiving selection data corresponding to a selection of a menu item, and, responsive to the selection data, controlling the wearable computing device to maintain the selected menu item substantially fully viewable in the view region and in a substantially fixed position in the view region that is substantially independent of further movement of the wearable computing device.

In a second aspect, a wearable computing device includes a display and at least one processor coupled to the display. The at least one processor is configured to control the display to provide a user-interface that includes (i) one or more menu items and (ii) a view region that defines an area in which the one or more menu items are selectively viewable. Further, the at least one processor is configured to receive movement data corresponding to movement of the wearable computing device from a first position to a second position and, responsive to the movement data, control the display such that the one or more menu items are viewable in the view region. The at least one processor is also configured to, while the one or more menu items are viewable in the view region, receive selection data corresponding to a selection of a menu item and, responsive to the selection data, control the display to maintain the selected menu item substantially fully viewable in the view region and in a substantially fixed position in the view region that is substantially independent of further movement of the wearable computing device.

In a third aspect, a non-transitory computer readable medium has stored therein instructions executable by at least one processor to cause the at least one processor to perform functions including controlling a computing device to provide a user-interface that has (i) one or more menu items and (ii) a view region that defines an area in which the one or more menu items are selectively viewable. The functions also include receiving movement data corresponding to movement of the computing device from a first position to a second position and, responsive to the movement data, controlling the computing device such that the one or more menu items are viewable in the view region. Further, the functions include, while the one or more menu items are viewable in the view region, receiving selection data corresponding to a selection of a menu item and, responsive to the selection data, controlling the computing device to maintain the selected menu item substantially fully viewable in the view region and in a substantially fixed position in the view region that is substantially independent of further movement of the computing device.

These as well as other aspects, advantages, and alternatives, will become apparent to those of ordinary skill in the art by reading the following detailed description, with reference where appropriate to the accompanying drawings.

### BRIEF DESCRIPTION OF THE FIGURES

FIG. 1 is a generally front isometric view of a system capable of receiving, transmitting, and/or displaying data, in accordance with an example embodiment;

FIG. 2 is a generally back isometric view of the system of FIG. 1;

FIG. 3 is a generally front isometric view of another system capable of receiving, transmitting, and/or displaying data, in accordance with an example embodiment;

FIG. 4 is a generally front, isometric view of another system capable of receiving, transmitting, and/or displaying data, in accordance with an example embodiment;

FIG. 5 is a block diagram of a computer network infrastructure, in accordance with an example embodiment;

FIG. 6 is a block diagram of a computing system that may be incorporated into the systems of FIGS. 1-4 and/or the infrastructure of FIG. 5, in accordance with an example embodiment;

FIGS. 7A-7K illustrate various states and aspects of a user-interface, in accordance with an example embodiment;

FIGS. 8A and 8B show various states and aspects of an example implementation of a user-interface of a wearable computing device;

FIG. 9 is a flowchart of processes for providing a user-interface, in accordance with an example embodiment; and

FIG. 10 is another flowchart of processes for providing a user-interface, in accordance with an example embodiment.

### DETAILED DESCRIPTION

The present disclosure includes details of a computing device that controls a display element to display a user-interface that includes information, such as text, images, video, etc., viewable by a user. In one example, a computing device can be configured as an augmented-reality device that displays a user-interface that is blended or overlaid with the user's field of view (FOV) of a real-world environment. Such a computing device can be a wearable computing device, for example, a near-eye display, a head-mountable display (HMD), or a heads-up display (HUD), which generally includes a display element configured to display a user-interface that overlays part or all of the FOV of the user. The displayed user-interface can supplement the user's FOV of the real-world with useful information related to the user's FOV. Alternatively or in conjunction, the displayed user-interface can include information unrelated to the user's FOV of the real-world, for example, the user-interface can include email or calendar information.

In one example, the user-interface includes a view region and interactive elements. The interactive elements may take the form of a menu and one or more selectable menu icons or menu objects. In one non-limiting example, the interactive elements can be made visible and can be interacted with when disposed within the view region. In embodiments where the user-interface is displayed by a wearable computing device, the view region may substantially fill a FOV of the wearable computing device. Further, the menu may not be fully visible in the view region at all times. For example, the menu may be disposed outside of the view region or otherwise hidden from view. Illustratively, the menu can be disposed above the view region, such that the menu is not visible at all in the view region or only a bottom portion of the menu is visible in the view region. Other examples are possible as well.

In one example, a wearable computing device, such as an HMD, is configured to receive movement data corresponding to movements of the user, such as head and/or eye movements, and to selectively display the menu within the view region in response to the movement data. More particularly, the wearable computing device may be configured with sensors, such as accelerometers, gyroscopes, compasses, and other input devices, to detect one or more predetermined triggering movements, such as an upward movement or tilt of the wearable computing device. In response to detecting the triggering movement, the wearable computing device may cause the menu to be viewable in the view region. For example, in response to detecting the triggering movement, one or both of the view region and the menu may move, such that the menu becomes more visible in the view region. Other examples are possible as veil, for example, the menu may become more visible by fading into the view region.

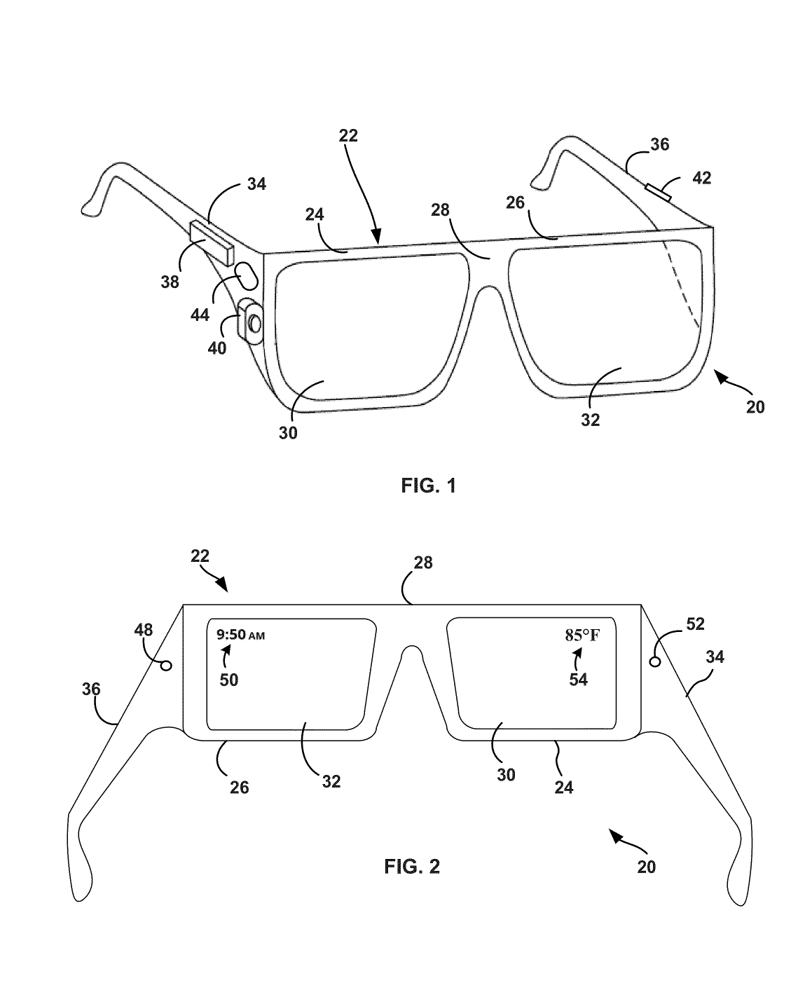

Referring now to FIG. 1, a non-limiting example of a wearable computing device 20 including an HMD 22 is shown. As illustrated in FIG. 1, the HMD 22 comprises frame elements, including lens frames 24, 26 and a center frame support 28, lens elements 30, 32, and extending side or support arms 34, 36. The center frame support 28 and the side arms 34, 36 are configured to secure the HMD 22 to a user's face via the user's nose and ears, respectively.

Each of the frame elements 24-28 and the side arms 34, 36 may be formed of a solid structure of plastic and/or metal, or may be formed of a hollow structure of similar material so as to allow wiring and component interconnections to be internally routed through the HMD 22. Other materials and designs may be possible as well.

One or more of the lens elements 30, 32 may be formed of any material that can suitably display a projected image or graphic. In one example, each of the lens elements 30, 32 are also sufficiently transparent to allow a user to see through the lens element. Combining these two features of the lens elements may facilitate an augmented reality display where a projected image or graphic is superimposed over a real-world view as perceived by the user through the lens elements 30, 32 so that the user can view the projected image and the real world simultaneously.

The side arms 34, 36 may each be projections that extend away from the lens frames 24, 26, respectively, and may be positioned behind a user's ears to help secure the HMD 22 to the user. The side arms 34, 36 may further secure the HMD 22 to the user by extending around a rear portion of the user's head. Additionally or alternatively, for example, the device 20 may connect to or be affixed within a head-mounted helmet structure. Other possibilities exist as well.

The device 20 may also include an on-board computing system 38, a video camera 40, a sensor 42, and a finger-operable touch pad 44. The computing system 38 is shown to be positioned on the side arm 34 of the HMD 22 in FIG. 1. However, in other examples, the computing system 38 may be provided on other parts of the HMD 22 or may be positioned remotely from the HMD, for example, the computing system 38 can be coupled via a wired or wireless link to the HMD. As such, the computing system 38 may include a suitable communication interface to facilitate such wired or wireless links. In one example, the computing system 38 includes a processor and memory. Further, in the present example, the computing system 38 is configured to receive and analyze data from the video camera 40 and the touch pad 44 and to generate images for output by or on the lens elements 30, 32. In other examples, the computing system 38 is configured to receive and analyze data from other sensory devices, user-interfaces, or both.

In FIG. 1, the video camera 40 is shown positioned on the side arm 34 of the HMD 22. However, in other examples, the video camera 40 may be provided on other parts of the HMD 22. The video camera 40 may be configured to capture images at any resolution or frame rate. Many types of video cameras with a small form-factor, such as those used in cell phones or webcams, for example, may be incorporated into various embodiments of the device 20.

Further, although FIG. 1 illustrates one video camera 40, more video cameras may be used and each camera may be configured to capture the same view or to capture different views. For example, the video camera 40 may be forward facing to capture at least a portion of the real-world view perceived by the user. Such forward facing image captured by the video camera 40 may then be used to generate an augmented reality where computer generated images relate to the FOV of the user.

The sensor 42 is shown on the side arm 36 of the HMD 22. However, in other examples, the sensor 42 may be positioned on other parts of the HMD 22. The sensor 42 may include one or more components for sensing movement of a user's head, such as one or more of a gyroscope, accelerometer, compass, and global positioning system (GPS) sensor, for example. Further, the sensor 42 may include optical components such as an emitter and a photosensor for tracking movement of a user's eye. Other sensing devices may be included within or in addition to the sensor 42 and other sensing functions may be performed by the sensor.

The touch pad 44 is shown on the side arm 34 of the HMD 22. However, in other examples, the touch pad 44 may be positioned on other parts of the HMD 22. In addition, more than one touch pad may be present on the HMD 22. Generally, a user may use the touch pad 44 to provide inputs to the device 22. The touch pad 44 may sense at least one of a position and a movement of a finger via capacitive sensing, resistance sensing, or a surface acoustic wave process, among other possibilities. The touch pad 44 may be capable of sensing finger movement in a direction parallel or planar to the pad surface, in a direction normal to the pad surface, or both, and may also be capable of sensing a level of pressure applied to the pad surface. The touch pad 44 may be formed of one or more translucent or transparent insulating layers and one or more translucent or transparent conducting layers. Edges of the touch pad 44 may be formed to have a raised, indented, or roughened surface, to provide tactile feedback to a user when the user's finger reaches the edge, or other area, of the touch pad. If more than one touch pad is present, each touch pad can be operated independently and each touch pad can provide a different function.

FIG. 2 illustrates an alternate view of the device 20 illustrated in FIG. 1. As shown generally in FIG. 2, the lens elements 30, 32 may act as display elements. The HMD 22 may include a first optical display element 48 coupled to an inside surface of the side arm 36 and configured to produce a user-interface 50 onto an inside surface of the lens element 32. Additionally or alternatively, a second optical display element 52 may be coupled to an inside surface of the side arm 34 and configured to project a user-interface 54 onto an inside surface of the lens element 30. The first and second optical elements 48, 52 can also be configured to image one or more of the user's eyes to track the gaze of the user.

The lens elements 30, 32 may act as a combiner in a light projection system and may include a coating that reflects the light projected onto them from the projectors 48, 52. In some embodiments, a reflective coating may not be used, for example, when the projectors 48, 52 are scanning laser devices.

In alternative embodiments, other types of display elements may also be used. For example, the lens elements 30, 32 may include a transparent or semi-transparent matrix display, such as an electroluminescent display or a liquid crystal display, one or more waveguides for delivering an image to the user's eyes, and/or other optical elements capable of delivering an in-focus near-to-eye image to the user. A corresponding display driver may be disposed within or otherwise coupled to the frame elements 24-28, for example, for driving such a matrix display. Alternatively or additionally, a laser or LED source and scanning system can be used to draw a raster display directly onto the retina of one or more of the user's eyes. Other possibilities exist as well.

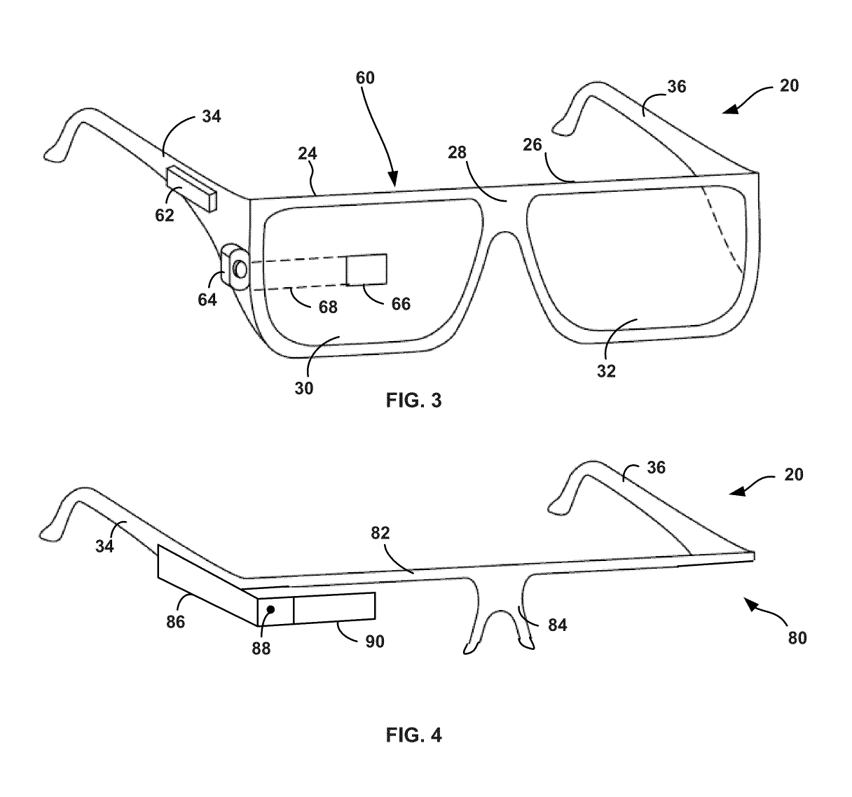

FIG. 3 illustrates another example wearable computing device 20 for receiving, transmitting, and/or displaying data in the form of an HMD 60. Like the HMD 22 of FIGS. 1 and 2, the HMD 60 may include frame elements 24-28 and side arms 32, 34. Further, the HMD 60 may include an on-board computing system 62 and a video camera 64, similarly to the HMD 22. In the present example, the video camera 64 is mounted on the side arm 34 of the HMD 60. However, in other examples, the video camera 64 may be mounted at other positions as well.

The HMD 60 illustrated in FIG. 3 also includes a display element 66, which may be coupled to the device in any suitable manner. The display element 66 may be formed on a lens element of the HMD 60, for example, on the lens elements 30, 32, as described with respect to FIGS. 1 and 2, and may be configured to display a user-interface overlaid on the user's view of the real-world world. The display element 66 is shown to be provided generally in a center of the lens 30 of the computing device 60. However, in other examples, the display element 66 may be provided in other positions. In the present example, the display element 66 can be controlled by the computing system 62 that is coupled to the display via an optical waveguide 68.

FIG. 4 illustrates another example wearable computing device 20 for receiving, transmitting, and displaying information in the form of an HMD 80. Similarly to the HMD 22 of FIGS. 1 and 2, the HMD 80 may include side-arms 34, 36, a center frame support 82, and a bridge portion with nosepiece 84. In the example shown in FIG. 4, the center frame support 82 connects the side-arms 34, 36. The HMD 80 may additionally include an on-board computing system 86 and a video camera 88, similar to those described with respect to FIGS. 1 and 2.

The HMD 80 may include a display element 90 that may be coupled to one of the side-arms 34, 36 or the center frame support 82. The display element 90 may be configured to display a user-interface overlaid on the user's view of the physical world. In one example, the display element 90 may be coupled to an inner side of the side arm 34 that is exposed to a portion of a user's head when the HMD 80 is worn by the user. The display element 90 may be positioned in front of or proximate to a user's eye when the HMD 80 is worn by a user. For example, the display element 90 may be positioned below the center frame support 82, as shown in FIG. 4.

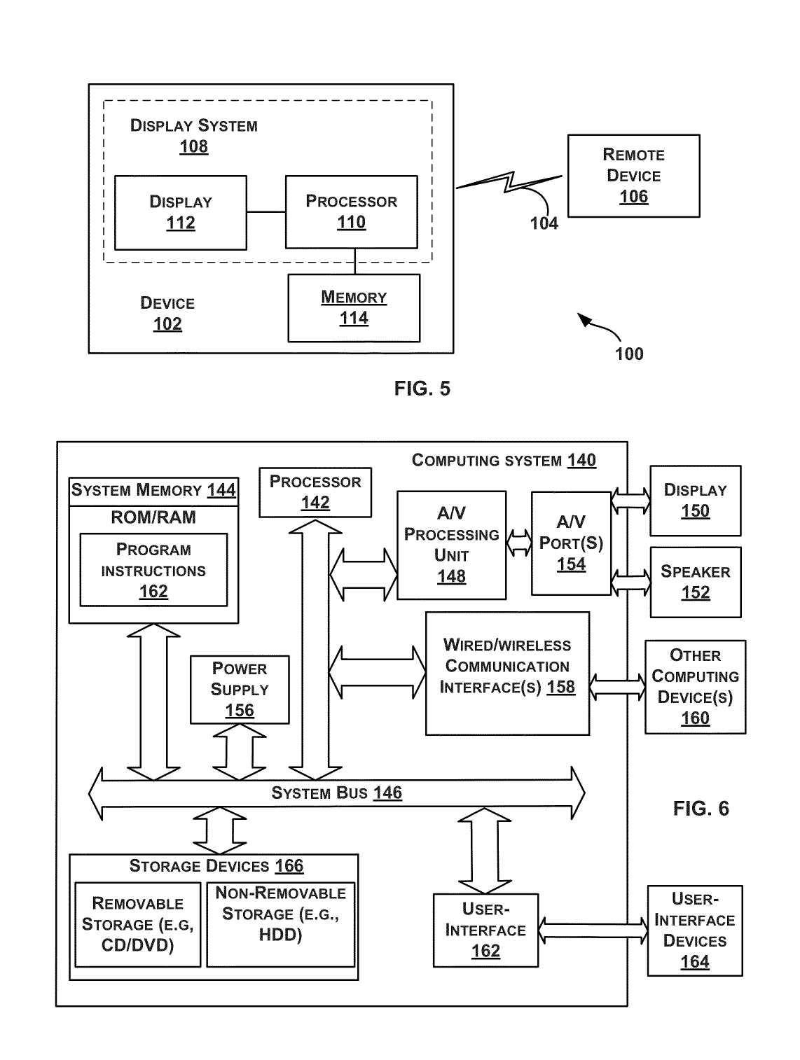

FIG. 5 illustrates a schematic drawing of a computer network infrastructure system 100, in accordance with one example. In the system 100, a device 102 communicates through a communication link 104 to a remote device 106. The communication link 104 can be a wired and/or wireless connection. The device 102 may be any type of device that can receive data and display information that corresponds to or is associated with such data. For example, the device 102 may be a wearable computing device 20, as described with respect to FIGS. 1-4.

Thus, the device 102 may include a display system 108 with a processor 110 and a display element 112. The display element 112 may be, for example, an optical see-through display, an optical see-around display, or a video see-through display. The processor 110 may receive data from the remote device 106 and configure the data for display on the display element 112. The processor 110 may be any type of processor, such as a micro-processor or a digital signal processor, for example.

The device 102 may further include on-board data storage, such as memory 114 coupled to the processor 110. The memory 114 may store program instructions that can be accessed and executed by the processor 110, for example.

The remote device 106 may be any type of computing device or transmitter including a laptop computer, a mobile telephone, tablet computing device, a server device, etc., that is configured to transmit data to the device 102 or otherwise communicate with the device 102. The remote device 106 and the device 102 may contain hardware and software to enable the communication link 104, such as processors, transmitters, receivers, antennas, program instructions, etc.

In FIG. 5, the communication link 104 may be a wireless connection using, for example, Bluetooth® radio technology, communication protocols described in IEEE 802.11 (including any IEEE 802.11 revisions), cellular technology (such as GSM, CDMA, UMTS, DO, WiMAX, or LTE), or Zigbee® technology, among other possibilities. In other examples, wired connections may also be used. For example, the communication link 104 may be a wired serial bus, such as a universal serial bus or a parallel bus. A wired connection may be a proprietary connection as well. The remote device 106 may be accessible via the Internet and may include a computing cluster associated with a particular web service, for example, social-networking, photo sharing, address book, etc.

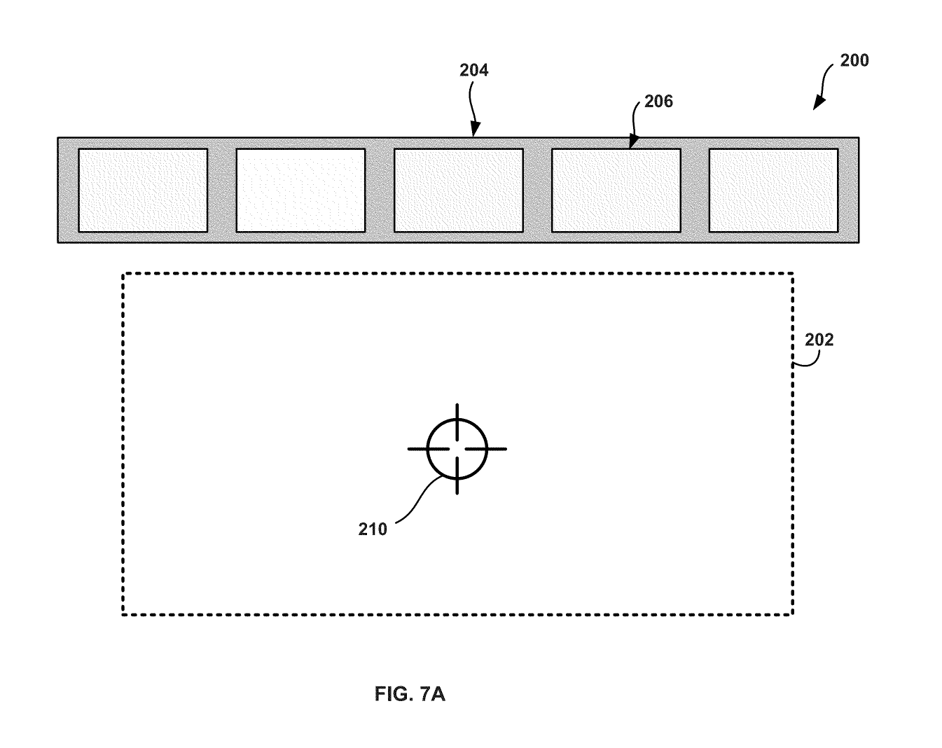

As described above in connection with FIGS. 1-4, an example wearable computing device may include, or may otherwise be communicatively coupled to, a computing system, such as computing system 38 or 62. FIG. 6 is a block diagram depicting example components of a computing system 140 in accordance with one non-limiting example. Further, one or both of the device 102 and the remote device 106 of FIG. 5, may include one or more components of the computing system 140.

The computing system 140 of FIG. 6 includes at least one processor 142 and system memory 144. In the illustrated embodiment, the computing system 140 includes a system bus 146 that communicatively connects the processor 142 and the system memory 144, as well as other components of the computing system. Depending on the desired configuration, the processor 142 can be any type of processor including, but not limited to, a microprocessor, a microcontroller, a digital signal processor, and the like. Furthermore, the system memory 144 can be of any type of memory now known or later developed including but not limited to volatile memory (such as RAM), non-volatile memory (such as ROM, flash memory, etc.), or any combination thereof.

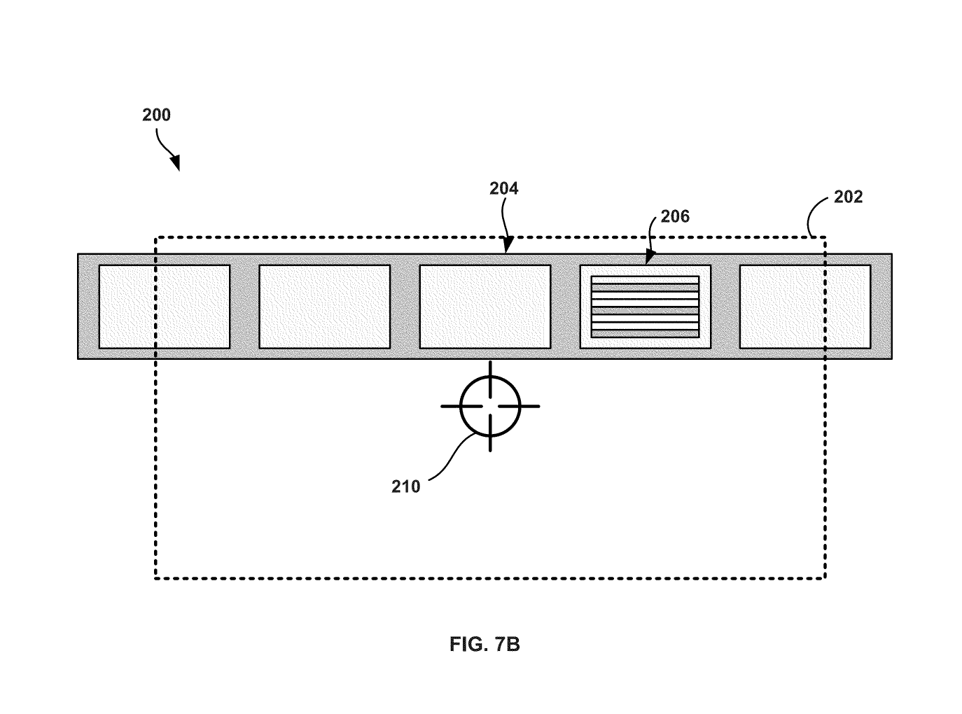

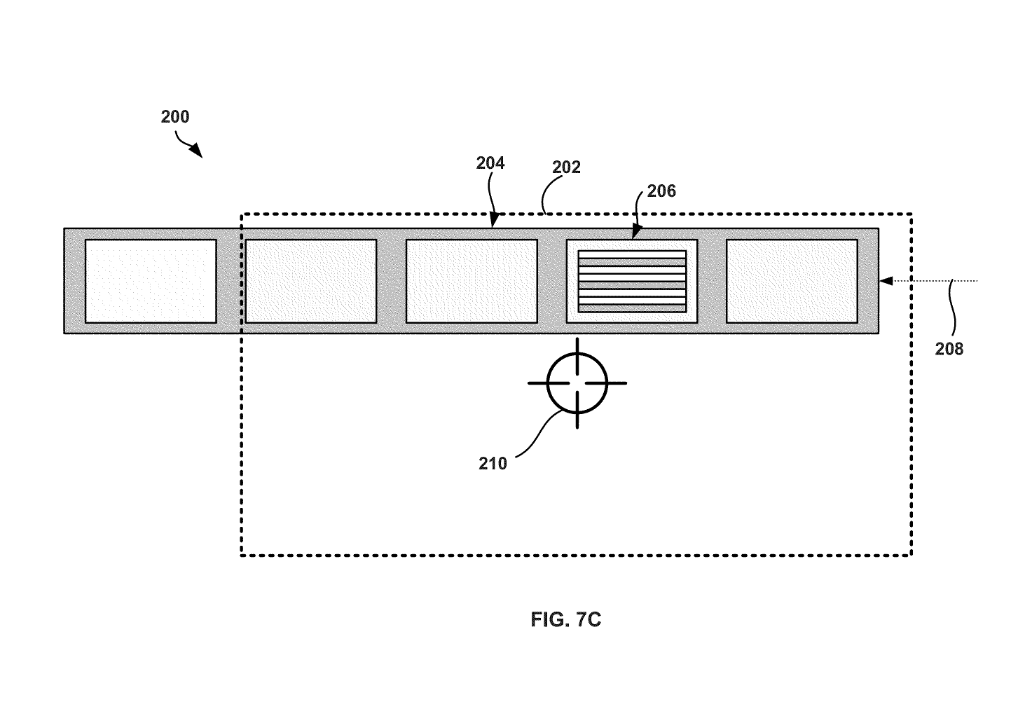

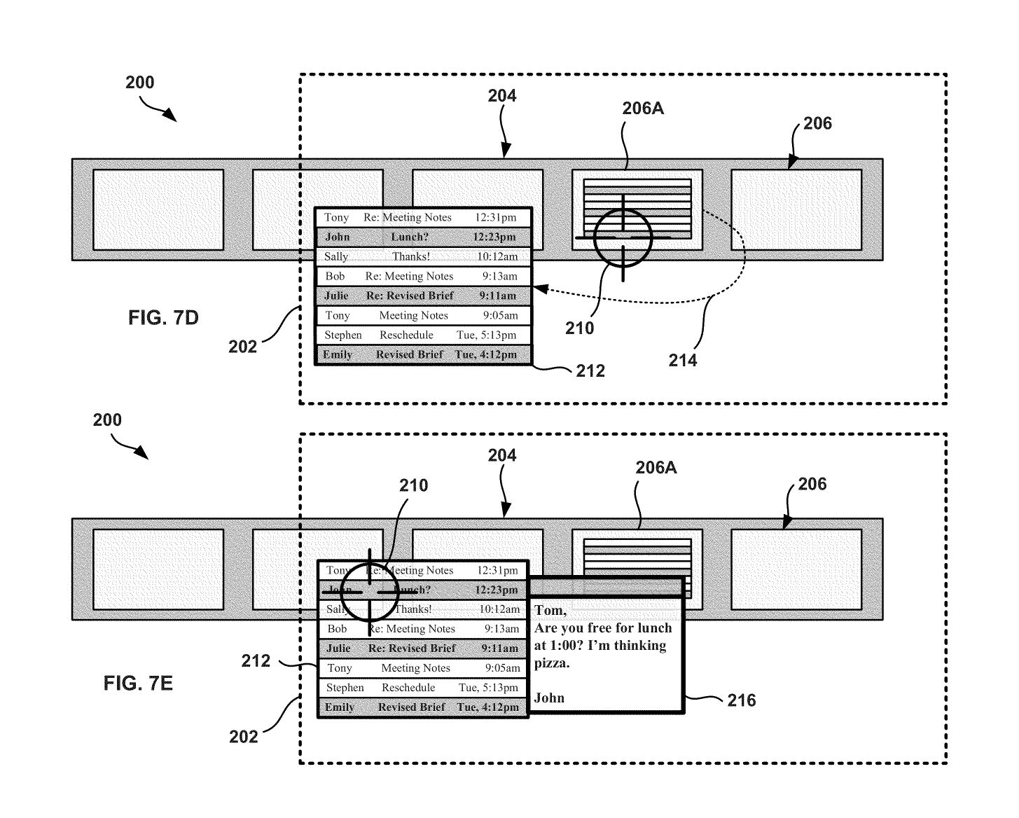

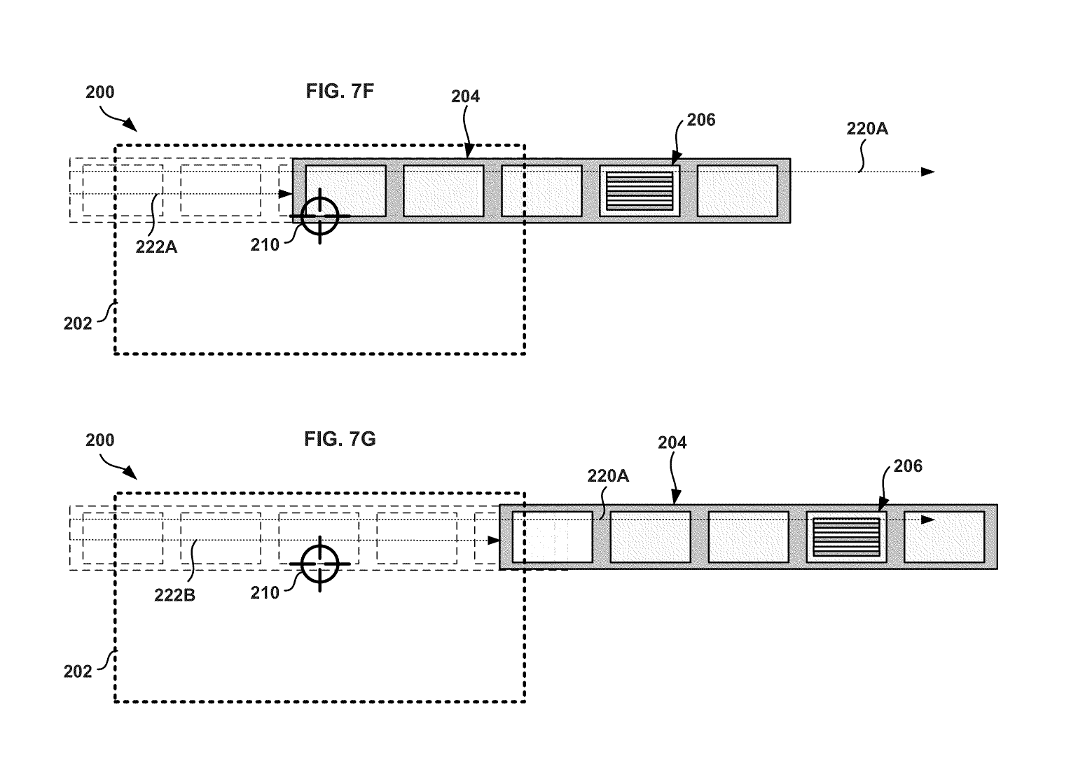

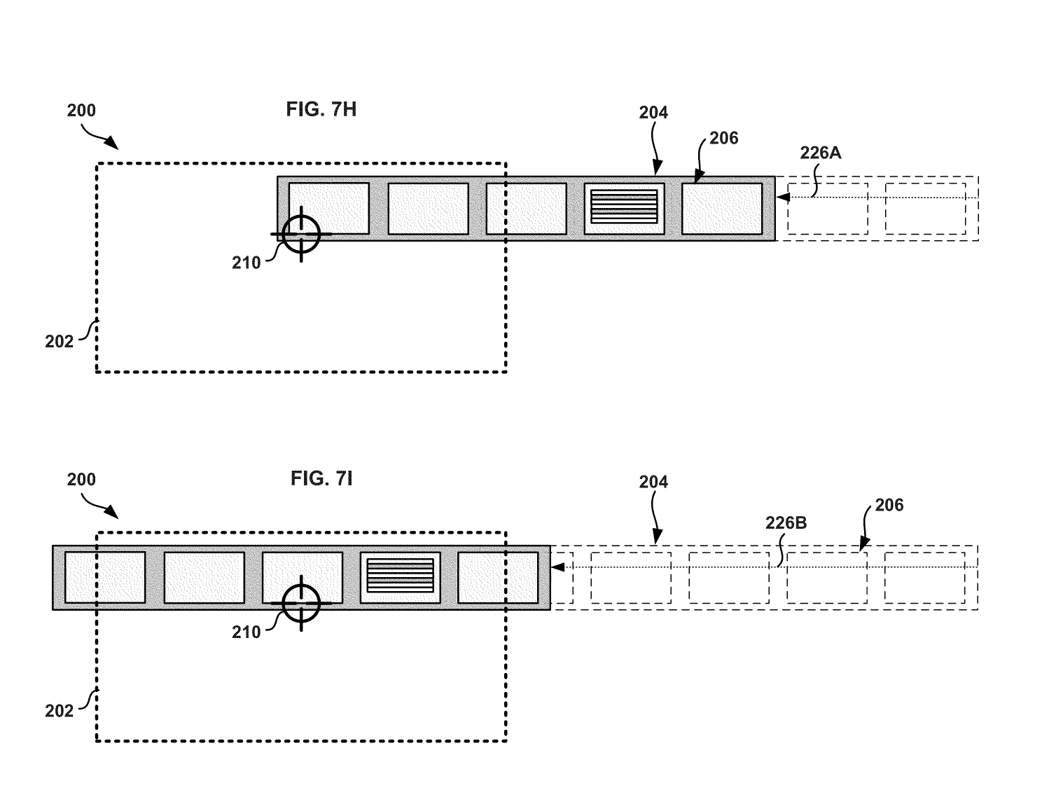

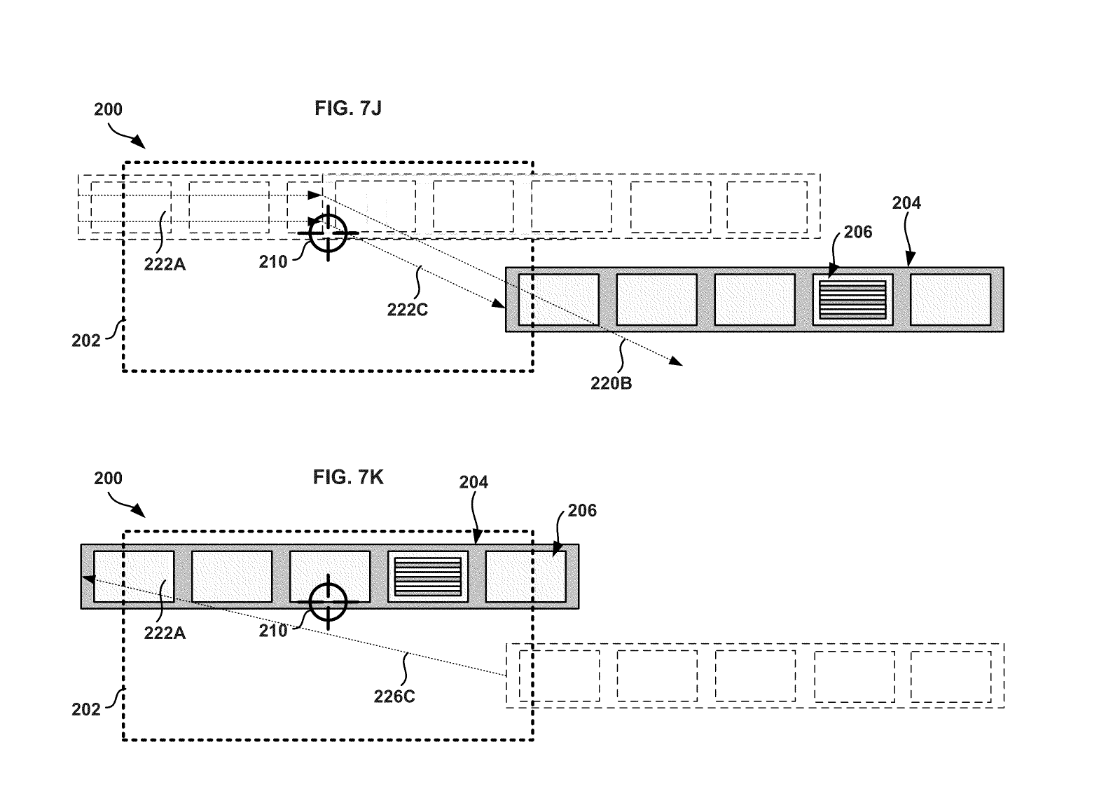

The computing system 140 of FIG. 6 also includes an audio/video (A/V) processing unit 148 for controlling a display element 150 and a speaker 152. The display element 150 and the speaker 152 can be coupled to the computing system 140 through an A/V port 154. Further, the illustrated computing system 140 includes a power supply 156 and one or more communication interfaces 158 for connecting to and communicating with other computing devices 160. The display element 150 may be arranged to provide a visual depiction of various input regions provided by a user-interface module 162. For example, the user-interface module 162 may be configured to provide a user-interface, such as examples user-interfaces described below in connection with FIGS. 7A-7K, and the display element 150 may be configured to provide a visual depiction of the user-interface. The user-interface module 162 may be further configured to receive data from and transmit data to, or be otherwise compatible with, one or more user-interfaces or input devices 164. Such user-interface devices 164 may include a keypad, touch pad, mouse, sensors, and other devices for receiving user input data.

Further, the computing system 140 may also include one or more data storage devices or media 166 implemented in any method or technology for storage of information, such as computer readable instructions, data structures, program modules, or other data. The storage media can include volatile and nonvolatile, removable and non-removable storage media, for example, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium now known or later developed that can be used to store the desired information and which can be accessed by the computing system 140.

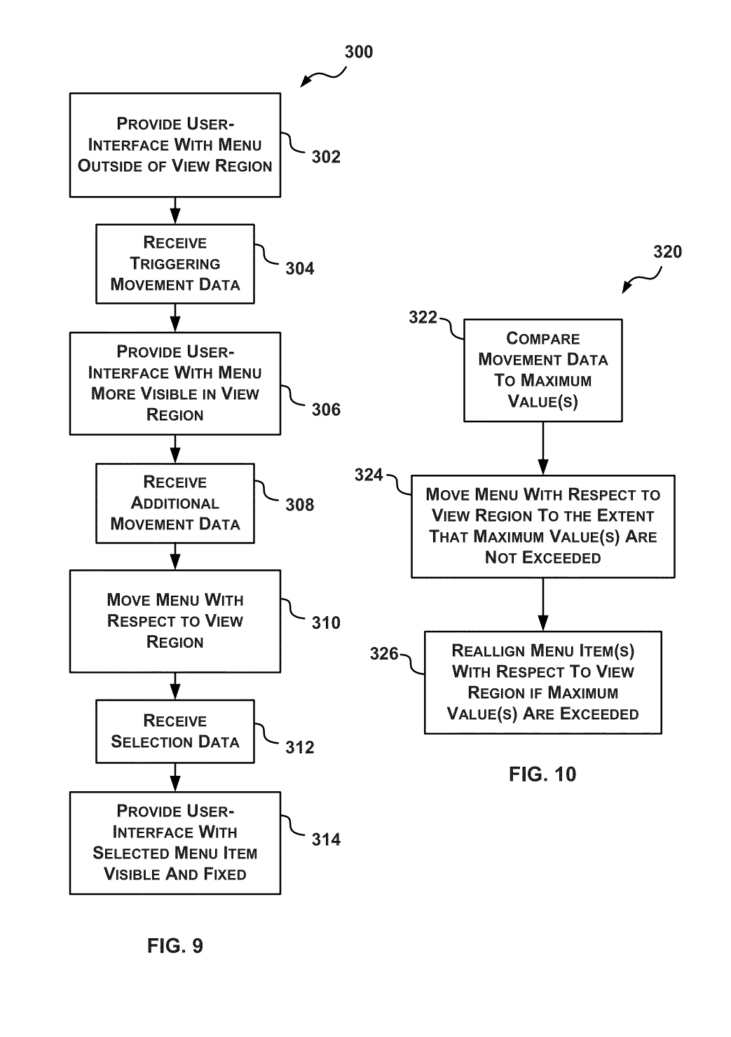

According to an example embodiment, the computing system 140 may include program instructions 168 stored in the system memory 144 (and/or possibly in another data-storage medium) and executable by the processor 142 to facilitate the various functions described herein including, but not limited to, those functions described with respect to FIGS. 9 and 10.

Although various components of the computing system 140 are shown as distributed components, it should be understood that any of such components could be physically integrated and/or distributed according to the desired configuration of the computing system.

Referring now to FIGS. 7A-7K, various aspects of a user-interface 200 are shown, in accordance with an embodiment. The user-interface 200 may be displayed by, for example, a wearable computing device, such as any of the wearable computing devices described above.

A first example state of the user-interface 200 is shown in FIG. 7A. The example state shown in FIG. 7A generally corresponds to a first position of the wearable computing device. That is, the user-interface 200 may be displayed as shown in FIG. 7A when the wearable computing device is in the first position. In some embodiments, the first position of the wearable computing device may correspond to a position of the wearable computing device when a user of the wearable computing device is looking in a direction that is generally parallel to the ground (e.g., a position that does not correspond to the user looking up or looking down). Other examples are possible as well.

As shown, the user-interface 200 includes a view region 202. Generally, the view region 202 defines an area or region within which a display element of the wearable computing device provides one or more visible or viewable elements or portions of a user-interface. In one example, a user can then select or otherwise interact with such one or more visible elements or portions of the user-interface. In another example, portions of the user-interface that are not visible in the view region 202 may not be selectable. A dashed frame in FIGS. 7A-7K represents an example boundary of the view region 202. While the view region 202 is shown to have a landscape shape (in which the view region has a greater width than height), in other embodiments the view region 202 may have a portrait or square shape, or may have a non-rectangular shape, such as a circular or elliptical shape. The view region 202 may have other shapes as well.

The view region 202 may include, for example, a viewable area between or encompassing upper, lower, left, and right boundaries of a display element of the wearable computing device. The view region 202 may thus be said to substantially fill a FOV of the wearable computing device.

As shown, when the wearable computing device is in the first position, as shown in FIG. 7A, the view region 202 is substantially empty of interactive elements, such as a menu 204, so that the user's view of the real-world environment is generally uncluttered and objects seen in the user's real-world environment are not obscured by computer displayed images. In other examples, a portion, such as a bottom edge, of the menu 204 may be disposed and visible in the view region 202 when the wearable computing device is in the first position.

In some embodiments, the view region 202 may correspond to a FOV of a user of the wearable computing device, and an area outside the view region may correspond to an area outside the FOV of the user. In other embodiments, the view region 202 may correspond to a non-peripheral portion of a FOV of a user of the wearable computing device and an area outside the view region may correspond to a peripheral portion of the FOV of the user. In still other embodiments, the view region 202 may be larger than a FOV of a user of the wearable computing device. The view region 202 may take other forms as well.

Generally, portions of the user-interface 200 outside of the view region 202 may be outside of or in a peripheral portion of a FOV of a user of the wearable computing device. For example, as shown in FIG. 7A, the menu 204 may be outside of or in a peripheral portion of a FOV of a user of the wearable computing device. In particular, the menu 204 is shown to be located above the view region 202 in FIG. 7A. In other examples, the menu 204 can be located below the view region 204 or can be located to a left or right side of the view region. While the menu 204 in FIG. 7A is shown to be not visible in the view region 202, in some embodiments the menu may be partially visible in the view region. In general, however, when the wearable computing device is in the first position, the menu 204 may not be fully visible in the view region 502.

In some embodiments, the wearable computing device may be configured to receive triggering movement data corresponding to, for example, an upward movement of the wearable computing device to a second position above the first position. In these embodiments, the wearable computing device may, in response to receiving the movement data corresponding to the upward movement, cause the menu 204 to be visible in the view region. For example, the wearable computing device may cause the view region 202 to move upward and/or may cause the menu 204 to move downward. The view region 202 and the menu 204 may move the same amount or may move different amounts in response to the movement data. In one embodiment, the menu 204 may move farther than the view region 202. As another example, the wearable computing device may cause only the menu 204 to move with respect to the view region 202. Other examples are possible as well.

In some embodiments, when the view region 202 moves, the view region may appear to a user of the wearable computing device as if mapped to an inside of a static sphere or cylinder centered generally at the wearable computing device. In the present embodiment, a scrolling or panning movement of the view region 202 may map to movement of the real-world environment relative to the wearable computing device. The view region 202 may move in other manners as well.

While the term “upward” is used to describe some examples, it is to be understood that the upward movement may encompass any movement having any combination of moving, tilting, rotating, shifting, sliding, or other movement that results in a generally upward movement. Further, in some embodiments “upward” may refer to an upward movement in the reference frame of a user of the wearable computing device. Other reference frames are possible as well. In embodiments where the wearable computing device is a head-mounted device, the upward movement of the wearable computing device may also be an upward movement of a user's head and/or eyes such as, for example, the user looking upward.

The movement data corresponding to the upward movement may take several forms. For example, the movement data may be or may be derived from data received from one or more movement sensors, accelerometers, and/or gyroscopes configured to detect the upward movement, such as the sensor 42 described above. In some embodiments, the movement data may comprise a binary indication corresponding to the upward movement. In other embodiments, the movement data may comprise an indication corresponding to the upward movement as well as an extent of the upward movement, such as a magnitude, speed, acceleration, and/or direction of the upward movement. The movement data may take other forms as well.

FIG. 7B shows an example of the user-interface 200 after receiving the triggering movement data corresponding, for example, to an upward movement of the wearable computing device. In response to receiving the triggering movement data, the wearable computing device may move one or both of the view region 202 and the menu 204 such that at least a portion of the menu is visible in the view region. The view region 202 and/or the menu 204 may be moved in several manners.

In some embodiments, in response to the triggering movement data, the view region 202 and/or the menu 204 may move in a scrolling, panning, sliding, dropping, and/or jumping motion. For example, the view region 202 may move upward and the menu 204 may scroll or pan downward into the view region. In some embodiments, the view region 202 may move back downward after the menu 204 is brought into view. For example, the view region 202 may move downward in response to the wearable computing device moving back toward the first position. In the present example, the menu 204 may be “pulled” downward as the view region 202 moves downward and thus may remain in the view region. As another example, in response to the triggering movement data, the menu 204 may fade into or gradually increase in visibility within the view region. Other examples are possible as well.

In some embodiments, a magnitude, speed, acceleration, and/or direction of the scrolling, panning, sliding, dropping, jumping, and/or fading in may be based at least in part on a magnitude, speed, acceleration, and/or direction of the movement data. Further, in some embodiments, the view region 202 and/or the menu 204 may be moved only when the triggering movement data exceeds a threshold speed, acceleration, and/or magnitude. In response to receiving data corresponding to a movement of the wearable computing device that exceeds such a threshold or thresholds, the view region 202 and/or the menu 204 may pan, scroll, slide, drop, jump, and/or fade in to display the menu 204 in the view region 202, as described above.

While the foregoing description focused on an upward triggering movement, it is to be understood that the wearable computing device could be configured to receive data corresponding to other directional movement or combination of movements, for example, downward, leftward, rightward, diagonal, etc., and that the view region 202 may be moved in response to receiving such movement data in a manner similar to that described above in connection with an upward movement.

In some embodiments, a user of the wearable computing device need not keep the wearable computing device at the second position to keep the menu 204 at least partially visible in the view region 202. Rather, the user may return the wearable computing device to a more comfortable position (e.g., at or near the first position), and the wearable computing device may move the menu 204 and the view region 202 substantially together, thereby keeping the menu at least partially visible in the view region. In this manner, the user may continue to interact with the menu 204 even after moving the wearable computing device to what may be a more comfortable position.

As shown in FIGS. 7A-7K, the menu 204 includes a number of interactive elements, such as menu icons or objects 206. In some embodiments, the menu 204 and the menu objects 206 may be arranged in a ring (or partial ring) around and above the head of a user of the wearable computing device. In other embodiments, the menu objects 206 may be arranged in a dome-shape above the user's head. The ring or dome may be centered around the wearable computing device and/or the user's head. In other embodiments, the menu objects 206 may be arranged in other ways as well.

The number of menu objects 206 in the menu 204 may be fixed or may be variable. In embodiments where the number is variable, the menu objects 206 may vary in size according to the number of menu objects in the menu 204.

Depending on the application of the wearable computing device, the menu objects 206 may take several forms. For example, the menu objects 206 may include one or more of people, contacts, groups of people and/or contacts, calendar items, lists, notifications, alarms, reminders, status updates, incoming messages, recorded media, audio recordings, video recordings, photographs, digital collages, previously-saved states, webpages, and applications, as well as tools, such as a still camera, a video camera, and an audio recorder. The menu objects 206 may take other forms as well.

In embodiments where the menu objects 206 include tools, the tools may be located in a particular region of the menu 204, such as generally around a center of the menu. In some embodiments, the tools may remain in around the center of the menu 204, even if other menu objects 206 rotate, as described herein. Tool menu objects may be located in other regions of the menu 204 as well.

Particular menu objects 206 that are included in the menu 204 may be fixed or variable. For example, the menu objects 206 may be preselected by a user of the wearable computing device. In another embodiment, the menu objects 206 may be automatically assembled by the wearable computing device from one or more physical or digital contexts including, for example, people, places, and/or objects surrounding the wearable computing device, address books, calendars, social-networking web services or applications, photo sharing web services or applications, search histories, and/or other contexts. Further, some menu objects 206 may fixed, while other menu objects may be variable. The menu objects 206 may be selected in other manners as well.

Similarly, an order or configuration in which the menu objects 206 are displayed may be fixed or variable. In one embodiment, the menu objects 206 may be pre-ordered by a user of the wearable computing device. In another embodiment, the menu objects 206 may be automatically ordered based on, for example, how often each menu object is used (on the wearable computing device only or in other contexts as well), how recently each menu object was used (on the wearable computing device only or in other contexts as well), an explicit or implicit importance or priority ranking of the menu objects, and/or other criteria.

As shown in FIG. 7B, for example, a portion of the menu 204 may be selectively visible in the view region 202. In particular, while the menu 204 is generally aligned vertically within the view region 202, the menu may extend horizontally beyond the view region such that a horizontal portion of the menu is outside the view region. As a result, one or more menu objects 206 may be only partially visible in the view region 202, or may not be visible in the view region at all. Illustratively, in embodiments where the menu objects 206 are mapped to extend circularly around a user's head, like a ring or partial ring, a number of the menu objects may be outside the view region 202.

In order to view menu objects 206 located outside of the view region 202, a user of the wearable computing device may interact with the wearable computing device to, for example, pan around the menu or rotate the menu objects along a path (e.g., left or right, clockwise or counterclockwise) around the user's head. To this end, the wearable computing device may, in some embodiments, be configured to receive panning movement data indicative of a direction.

The panning movement data may take several forms. For example, the panning data may be (or may be derived from data received from one or more movement sensors, accelerometers, gyroscopes, and/or detectors configured to detect one or more predetermined movements. The one or more movement sensors may be included in the wearable computing device, like the sensor 42, or may be included in a peripheral device communicatively coupled to the wearable computing device. As another example, the panning data may be (or may be derived from) data received from a touch pad, such as the finger-operable touch pad 44 described above, or some other input device included in or coupled to the wearable computing device and configured to detect one or more predetermined movements. In some embodiments, the panning data may take the form of a binary indication corresponding to the predetermined movement. In other embodiments, the panning data may comprise an indication corresponding to the predetermined movement, as well as, an extent of the predetermined movement, for example, a magnitude, speed, and/or acceleration of the predetermined movement. The panning data may take other forms as well.

The predetermined movements may take several forms. In some embodiments, the predetermined movements may be certain movements or sequence of movements of the wearable computing device or a peripheral device. In some embodiments, the predetermined movements may include one or more predetermined movements defined as the lack of or substantial lack of movement for a predetermined period of time. In embodiments where the wearable computing device is a head-mounted device, one or more predetermined movements may involve a predetermined movement of the user's head (which is assumed to move the wearable computing device in a corresponding manner). Alternatively or additionally, the predetermined movements may involve a predetermined movement of a peripheral device communicatively coupled to the wearable computing device. The peripheral device may similarly be wearable by a user of the wearable computing device, such that the movement of the peripheral device may follow a movement of the user, such as, for example, a movement of the user's hand. Still alternatively or additionally, one or more predetermined movements may be, for example, a movement across a finger-operable touch pad or other input device. Other predetermined movements are possible as well.

In these embodiments, in response to receiving the panning data, the wearable computing device may move the view region 202 and/or the menu 204 based on the panning data, such that a portion of the menu including one or more menu objects 204 that were previously outside of the view region 202 are viewable in the view region.

FIG. 7C shows an example of the user-interface 200 after receiving panning data indicating a direction, as represented by dashed arrow 208. More particularly, in response to the panning data 208, the menu 204 has been moved generally to the left with respect to the view region 202. To this end, the panning data may have indicated, for example, that the user turned the user's head to the right, and the wearable computing device may have responsively panned through the menu 204 to the left. Alternately, the panning data may have indicated, for example, that the user tilted the user's head to the left or moved in some other fashion. Other examples are possible as well. For example, the panning data may cause the view region 202 and the menu 204 to move vertically and/or diagonally with respect to one another.

While the menu 204 is shown to extend horizontally beyond the view region 202, in some embodiments the menu may be fully visible in the view region.

Referring now to FIG. 7D, in some embodiments, the wearable computing device may be further configured to receive selection data from the user corresponding to a selection of a menu object 206 from the menu 204. To this end, the user-interface 200 may include a cursor 210, as shown in FIG. 7D as a reticle, which may navigated around the view region 202 to select menu objects 206 from the menu 204. Alternatively, the cursor 210 may be “locked” in the center or some other portion of the view region 202 and the menu 204 may be static with respect to the wearable computing device. In the present example, the view region 202, along with the locked cursor 210, may be navigated over the static menu 204 to select menu objects 206 therefrom. In some embodiments, the cursor 210 may be controlled by a user of the wearable computing device through one or more predetermined movements. Accordingly, the wearable computing device may be further configured to receive selection data corresponding to the one or more predetermined movements. The selection data may take any of the forms described herein in connection with the panning data, for example.

As shown in FIG. 7D, a user of the wearable computing device has navigated the cursor 210 to one of the menu objects 206A using one or more predetermined movements. In order to select the menu object 206A, the user may perform an additional predetermined movement, such as holding the cursor 210 over the menu object 206A for a predetermined period of time. The user may select the menu object 206A in other manners as well.

In some embodiments, the menu 204, the one or more menu objects 206, and/or other objects in the user-interface 200 may function as “gravity wells,” such that when the cursor 210 is within a predetermined distance of the object, the cursor is pulled toward the object by “gravity.” Additionally, the cursor 210 may remain on the object until a predetermined movement having a magnitude, speed, and/or acceleration greater than a predetermined threshold is detected. In this manner, a user may more easily navigate the cursor 210 to the object and hold the cursor over the object to select the object.

As seen in the example of FIG. 7D, once the menu object 206A is selected, the wearable computing device may cause the selected menu object to be displayed in the view region 202 as a selected menu object 212. As indicated by the dashed arrow 214, the menu object 206A is displayed in the view region 202 as the selected menu object 212. As shown, the selected menu object 212 is displayed larger and in more detail in the view region 202 than in the menu 204. In other embodiments, however, the selected menu object 212 could be displayed in the view region 202 smaller than or the same size as, and in less detail than or the same detail as, the menu 204. In some embodiments, additional content (e.g., actions to be applied to, with, or based on the selected menu object 212, information related to the selected menu object, and/or modifiable options, preferences, or parameters for the selected menu object, etc.) may be displayed adjacent to or nearby the selected menu object in the view region 202.

Once the selected menu object 212 is displayed in the view region 202, the selected menu object 212 can be fixed with respect to the view region 202, such that a user of the wearable computing device may interact with the selected menu object. For example, the selected menu object 212 of FIG. 7D is shown as an email inbox and the user may wish to read one of the mails in the email inbox. Depending on the selected menu object 212, the user may interact with the selected menu object in other ways as well (e.g., the user may locate additional information related to the selected menu object and may modify, augment, and/or delete the selected menu object, etc.). To this end, the wearable computing device may be further configured to receive input data corresponding to one or more predetermined movements or commands indicating interactions with the user-interface 200. The input data may take any of the forms described herein in connection with the movement data and/or the selection data.

FIG. 7E shows an example of the user-interface 200 after receiving input data corresponding to a user comment to interact with the selected menu object 212. As shown, a user of the wearable computing device has navigated the cursor 210 to a particular subject line in the email inbox 212 and has selected the subject line. As a result, an email 216 is displayed in the view region 202, so that the user may read the email. The user may interact with the user-interface 200 in other manners as well, depending on, for example, the selected menu object 212.

While provided in the view region 202, the selected menu object 212 and any objects associated with the selected menu object (e.g., the email 216) may be “locked” to the center or some other portion of the view region. That is, if the view region 202 moves for any reason (e.g., in response to movement of the wearable computing device), the selected menu object 212 and any objects associated with the selected menu object may remain locked with respect to the view region, such that the selected menu object and any objects associated with the selected menu object appear to a user of the wearable computing device not to move. This may make it easier for a user of the wearable computing device to interact with the selected menu object 212 and any objects associated with the selected menu object, even while the wearer and/or the wearable computing device are moving.

In some embodiments, the wearable computing device may be further configured to receive from the user a request to remove the menu 204 from the view region 202. To this end, the wearable computing device may be further configured to receive removal data corresponding to the one or more predetermined movements. Once the menu 204 is removed from the view region 202, the user-interface 200 may return to the arrangement shown in FIG. 7A.

Such removal data may take any of the forms described herein in connection with the movement data and/or panning data. In some embodiments, the wearable computing device may be configured to receive movement data corresponding to, for example, another upward movement. For example, the wearable computing device may move the menu 204 and/or view region 202 to make the menu more visible in the view region in response to a first upward movement, as described above, and may move the menu and/or view region to make the menu less visible (e.g., not visible) in the view region in response to a second upward movement. As another example, the wearable computing device may make the menu 204 disappear in response to a predetermined movement across a touch pad. Other examples are possible as well.

Referring now to FIGS. 7F-7K, additional illustrative aspects of the user-interface 200 are shown. Generally, as described above, the wearable computing device may receive panning data to move the view region 202 and/or the menu 204 so that different portions of the menu 204 are viewable within the view region 202. More particularly, in FIG. 7F, the wearable computing device receives panning data represented by a dashed arrow 220A that extends generally to the right beyond the view region 202. In response to the panning data 220A, the menu 204 starts to move or pan generally to the right with respect to the view region 202, as represented by a dashed arrow 222A.

Referring to FIG. 7G, the menu 204 continues to move or pan to the right in accordance with the panning data 220A, as represented by a dashed arrow 222B. However, if a determination is made that the panning data 220A does not stay within a predetermined movement range, then the menu 204 stops panning within the view region 202. Illustratively, in FIGS. 7F and 7G, the panning data 220A represents a movement of the menu 204 beyond the boundaries of the view region 202 and outside of a predetermined movement range. Consequently, in FIG. 7G, the wearable computing device has determined that the panning data 220A exceeds the predetermined movement range and, thus, has moved the menu 204 to a lesser extent, as represented by the arrow 222B, than would otherwise be dictated solely based on the panning data 220A.

Generally, the predetermined movement range may be based on maximum movement data value(s) that include one or more of maximum distance, velocity, and/or acceleration data values relating to movement of the wearable computing device. Illustratively, the maximum movement data value(s) may be set to prevent the view menu 204 from being moved too far outside of the view region 204. Alternatively or in addition, the maximum movement data value(s) may be set to prevent movements of the view region 202 and the menu 204 with respect to each other in response to certain movements of the wearable computing device. For example, a movement of the wearable computing device as a user turns a corner may not be intended to cause movements of the view region 202 and/or the menu 204. Thus, in the example of FIGS. 7F and 7G, the panning data 220A may correspond to a user turning a corner and the wearable computing device has stopped moving the view region 202 in response to the panning data past a certain point dictated by the predetermined movement range so that the view region does not move entirety beyond the menu 204.

FIGS. 7H and 7I illustrate another example, where the wearable computing device has generally realigned the view region 202 and the menu 204 after moving the menu in response to the panning data 220A, as shown in FIGS. 7F and 7G. More particularly, the wearable computing device may realign the view region 202 and the menu 204 in response to determining that the panning data 220A exceeds the predetermined movement range or maximum movement data value(s). In FIG. 7H, the wearable computing device starts to move or pan the menu 204 generally to the left within the view region 202, as indicated by a dashed arrow 226A. In FIG. 7I, the wearable computing device continues to move or pan the menu 204 generally to the left to realign the menu in the view region 202. FIG. 7I shows that the menu 204 and the view region 202 can be realigned to the general positions that the menu and the view region were in before the menu and/or view region were moved in response to the panning data 220A of FIGS. 7F and 7G. In another example, the wearable computing device may not realign the menu 204 and/or the view region 202 entirely back to the positions shown in FIG. 7F. Instead, the wearable computing device may move the menu 204 and/or the view region 202 generally toward the positions in FIG. 7F but not all the way, such as shown in FIG. 7H, for example. The realignment process illustrated in FIGS. 7H and 7I can move the menu 204 in a generally opposite manner to retrace the movements or panning performed in response to the panning data 220A.

In another example, the realignment process may ignore changes in direction of the panning data and, instead, may move the menu 204 and/or the view region 202 directly back toward a realignment position, such as the position illustrated in FIG. 7F. FIGS. 7J and 7K illustrate such an example where the panning data 220B includes a change in direction that causes a corresponding change in direction as the wearable computing device pans the menu 204 in the view region 202. More particularly, the panning data 220B may cause a movement of the menu 204 indicated by a dashed line 222C. In the present example, the panning data 220B does not stay within a predetermined movement range, thus, the menu 204 stops panning within the view region 202, as shown in FIG. 7J. In response to a determination that the panning data 220B does not stay within the predetermined movement range, the wearable computing device moves the menu 204 toward the original alignment position of FIG. 7F. However, instead of retracing the movements 222C of FIG. 7J, the wearable computing device moves the menu directly back toward the realignment position, as represented by a dashed line 226C.

Other examples of realigning the view region 202 and the menu 204 in response to the panning data 220 exceeding one or more maximum data values are also possible.

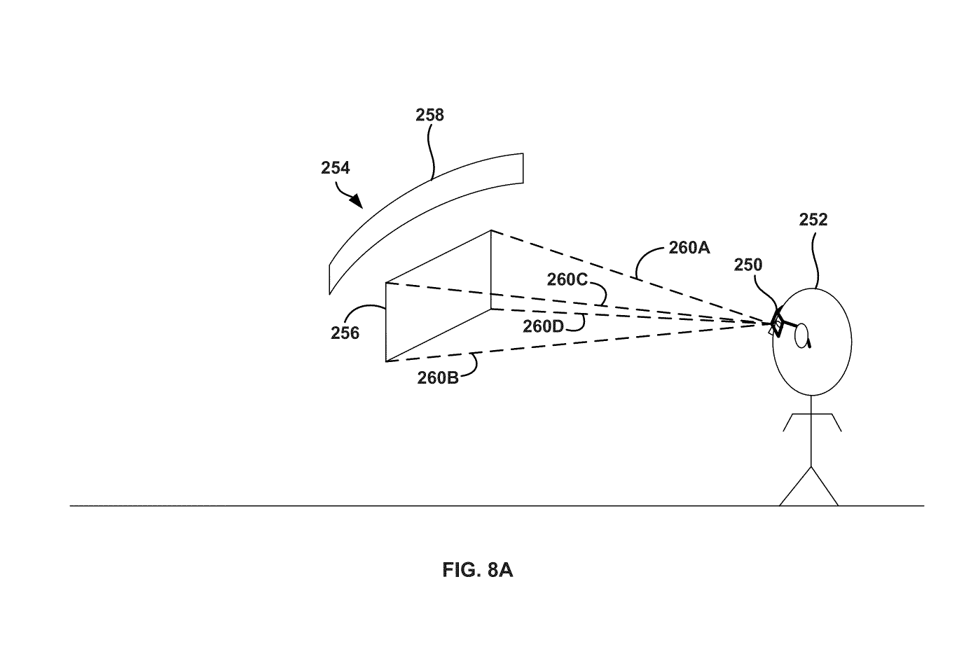

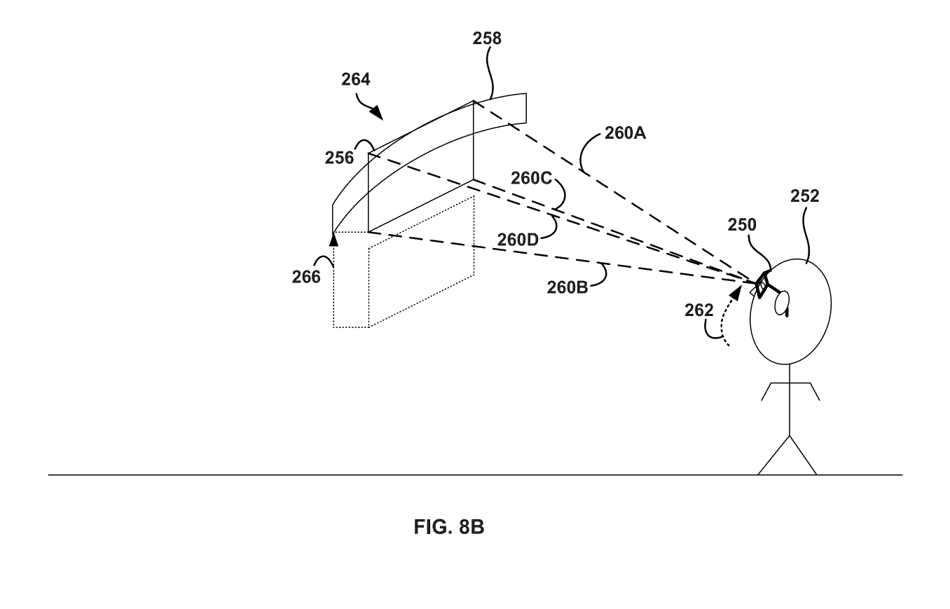

It is to be understood that each of the user-interfaces described herein is merely an illustrative state of the disclosed user-interface, and that the user-interface may move between the described and other states according to one or more types of user input to a computing device and/or a user-interface in communication with the computing device. That is, the disclosed user-interface is not a static user-interface, but rather is a dynamic user-interface configured to move between several states. Movement between states of the user-interface is described in connection with FIGS. 8A and 8B, which show an example implementation of an example user-interface, in accordance with an embodiment.

FIG. 8A shows an example implementation of a user-interface on a wearable computing device 250 when the wearable computing device is at a first position. As shown in FIG. 8A, a user 252 wears the wearable computing device 250. In response to receiving data corresponding to a first position of the wearable computing device 250 (e.g., a position of the wearable computing device when the user 252 is looking in a direction that is generally parallel to the ground, or another comfortable position), the wearable computing device provides a first state 254 of a user-interface, which includes a view region 256 and a menu 258.

Example boundaries of the view region 256 are shown by the dashed lines 260A-260D. The view region 256 may substantially fill a FOV of the wearable computing device 250 and/or of the user 252.

As shown, in the first state 254, the view region 256 is substantially empty. More particularly, in the first state 254, the menu 258 is not fully visible in the view region 256 because some or all of the menu is disposed above the view region. As a result, the menu 258 is not fully visible to the user 252. For example, the menu 258 may be visible only in a periphery of the FOV of the user 252 or may not be visible at all. Other examples are possible as well.

In FIG. 8A, the menu 258 is shown to be arranged in a partial ring located above the view region 256. In some embodiments, the menu 258 may extend farther around the user 252, forming a full ring. The (partial or full) ring of the menu 258 may be substantially centered over the wearable computing device 250 and/or the user 252.

Referring to FIG. 8B, at some point, the user 252 may perform a triggering movement 262 with the wearable computing device 250, for example, the user may look upward. As a result of the triggering movement 262, the user-interface transitions from the first state 254 to a second state 264. As shown in FIG. 8B, in the second state 264, the menu 258 is more visible in the view region 256, as compared with the first state 254. In various examples of the second state 264, the menu 258 may be substantially fully visible or only partially visible in the view region 256.

As shown, the wearable computing device 250 provides the second state 264 by moving the view region 256 upward, as represented by a dashed line 266. In other embodiments, the wearable computing device 250 may provide the user-interface in the second state 264 by moving the menu 258 downward into the view region 56. In still other embodiments, the wearable computing device 250 may provide the user-interface in the second state 264 by moving the view region 256 upward and moving the menu 258 downward. While the menu 258 is visible in the view region 256, as shown in the second state 264, the user 252 may interact with the menu, as described herein.

It will be understood that movement between states of the user-interface may involve a movement of the view region 256 over a static menu 258 and/or a movement of the menu within a static view region.

In some embodiments, movement between states of the user-interface may be gradual and/or continuous. Alternately, movement between the states of the user-interface may be substantially instantaneous. In some embodiments, the user-interface may move between states only in response to movements of the wearable computing device that exceed a certain threshold of magnitude. Further, in some embodiments, movement between states may have a speed, acceleration, magnitude, and/or direction that corresponds to the movements of the wearable computing device. Movement between the states may take other forms as well.

FIGS. 9 and 10 are flowcharts depicting methods 300, 320, respectively, that can be performed in accordance with example embodiments to control a computing device, such as the wearable computing device 20 of FIGS. 1-4, to provide a user-interface. Generally, the processes of the methods 300, 320 can be implemented through hardware components and/or through executable instructions stored in some form of computer readable storage medium and executed by one or more processors coupled to or otherwise in communication with the computing device. For example, the executable instructions can be stored on some form of non-transitory, tangible, computer-readable storage medium, such as magnetic or optical disk, or the like.

Illustratively, the device 20 of FIGS. 1-4 can implement the processes of the methods 300, 320. Alternatively or in conjunction, a network server or other device, which may be represented by the device 106 of FIG. 5, can implement the processes of the methods 300, 320 using head and/or eye-movement data obtained and transmitted by the device 20, for example. However, it should be understood that other computing systems and devices or combinations of computing systems and devices could implement the methods 300, 320.

As shown in FIG. 9, at block 302, a wearable computing device provides a user-interface with a view region and a menu, such as the user-interface 200 of FIGS. 7A-7K, for example. More particularly, at the block 302, the wearable computing device can provide a user-interface in a first state, in which the menu is generally disposed outside of or otherwise not fully visible within the view region.

At block 304, the wearable computing device receives triggering movement data, which corresponds to a triggering movement of the wearable computing device. Illustratively, the triggering movement can be an upward movement of the wearable computing device, as described herein. In response to the triggering movement, at block 306, the wearable computing device provides the user-interface in a second state with the menu and one or more selectable menu objects thereof viewable in the view region.

Thereafter, at block 308, the wearable computing device receives additional movement data corresponding to subsequent movement of the wearable computing device. In response to the additional movement data, at block 310, the wearable computing device moves or pans the view region, the menu, and/or the menu's associated menu object(s) so that successive portions of the menu are viewable or displayed in the view region. As discussed above, the view region and/or the menu can be moved with respect to one another in various ways.

Further, at block 312, the wearable computing device receives selection data, for example, data that corresponds to a cursor of the user-interface remaining stationary for a predetermined period of time over a menu item to be selected. Other examples of selection data are also possible. In response to the selection data, at block 314, the wearable computing device provides the selected menu item substantially fully visible in the view region. In one example, at the block 314, the wearable computing device also provides the selected menu item generally fixed with respect to the view region and substantially independent of further movement data.

Various modifications can be made to the flowchart 300 of FIG. 9. For example, the block 310 may include additional processes as illustrated by the flowchart 320 of FIG. 10. In FIG. 10, at block 322 the wearable computing device compares received movement or panning data corresponding to movement of the wearable computing device, such as the data received at the block 308 of FIG. 9, to a predetermined movement range, which can be based on one or more maximum movement data values. The maximum data values may include, for example, maximum distance, velocity, and/or acceleration data values, as described herein. Responsive to the comparison of block 322, at block 324, the wearable computing device moves or pans the view region, the menu, and/or the menu's associated menu object(s) to the extent that the movement data stays within the movement range and does not exceed the maximum data value(s).

Thereafter, at block 326, the wearable computing device can realign the view region, the menu, and the menu's associated menu object(s) with respect to one another. For example, at the block 326 the wearable computing device can move the view region and the menu back to a state of the user-interface before the processes of block 324 were executed.

Although the blocks 302-314 and 322-326 are generally illustrated in a sequential order, the blocks may also be performed in parallel, and/or in a different order than described herein. In addition, methods 300, 320 may include additional or fewer blocks, as needed or desired. For example, the various blocks 302-314, 322-326 may be combined into fewer blocks, divided into additional blocks, and/or removed based upon a desired implementation.

In the present detailed description, reference is made to the accompanying figures, which form a part thereof. In the figures, similar symbols typically identify similar components, unless context dictates otherwise. The illustrative embodiments described in the detailed description, figures, and claims are not meant to be limiting. Other embodiments may be utilized, and other changes may be made, without departing from the spirit or scope of the subject matter presented herein. It will be readily understood that the aspects of the present disclosure, as generally described herein, and illustrated in the figures, can be arranged, substituted, combined, separated, and designed in a wide variety of different configurations, all of which are contemplated herein.

1. A computer-implemented method comprising:
controlling a wearable computing device to provide a user-interface, wherein the user-interface includes (i) one or more menu items and (ii) a view region that defines an area in which the one or more menu items are selectively viewable;
receiving movement data corresponding to movement of the wearable computing device from a first position to a second position;
responsive to the movement data, controlling the wearable computing device such that the one or more menu items are viewable in the view region;
while the one or more menu items are viewable in the view region, receiving selection data corresponding to a selection of a menu item; and
responsive to the selection data, controlling the wearable computing device to maintain the selected menu item substantially fully viewable in the view region and in a substantially fixed position in the view region that is substantially independent of further movement of the wearable computing device.

2. The method of claim 1, wherein the one or more menu items are not selectable when the wearable computing device is at the first position.

3. The method of claim 1, wherein, when the wearable computing device is at the first position, the one or more menu items are located above the view region, and wherein the movement data corresponds to a generally upward movement of the wearable computing device to the second position.

4. The method of claim 1, further comprising, responsive to the movement data, controlling the wearable computing device to provide one or more first representations of the one or more menu items visible in the view region, and wherein, responsive to the selection data, controlling the wearable computing device to provide a second representation of the selected menu item in the view region.

5. The method of claim 4, wherein the second representation is larger and more detailed than the first representation.

6. The method of claim 1, further comprising controlling the wearable computing device to provide a cursor in the view region, wherein the selection data comprises cursor movement data corresponding to movement of the cursor in the view region.

7. The method of claim 6, wherein the selection data comprises cursor movement data corresponding to the cursor remaining substantially stationary over the selected menu item for a predetermined period of time.

8. The method of claim 6, wherein the cursor movement data corresponds to movement of the wearable computing device.

9. The method of claim 1, wherein the one or more menu items are arranged along an at least partial ring defined around the wearable computing device.

10. A wearable computing device comprising:
a display; and
at least one processor coupled to the display and configured to:
control the display to provide a user-interface, wherein the user-interface includes (i) one or more menu items and (ii) a view region that defines an area in which the one or more menu items are selectively viewable,
receive movement data corresponding to movement of the wearable computing device from a first position to a second position,
responsive to the movement data, control the display such that the one or more menu items are viewable in the view region,
while the one or more menu items are viewable in the view region, receive selection data corresponding to a selection of a menu item, and
responsive to the selection data, control the display to maintain the selected menu item substantially fully viewable in the view region and in a substantially fixed position in the view region that is substantially independent of further movement of the wearable computing device.

11. The wearable computing device of claim 10, further comprising a movement sensor configured to detect one or more of the movement data and the selection data

12. The wearable computing device of claim 10, wherein the one or more menu items are not selectable when the wearable computing device is at the first position.

13. The wearable computing device of claim 10, wherein, when the wearable computing device is at the first position, the one or more menu items are located above the view region, and wherein the movement data corresponds to a generally upward movement of the wearable computing device to the second position.

14. The wearable computing device of claim 10, wherein the at least one processor is further configured to control the display, responsive to the movement data, to provide one or more first representations of the one or more menu items visible in the view region, and to control the display, responsive to the selection data, to provide a second representation of the selected menu item in the view region, and wherein the second representation is larger and more detailed than the first representation.

15. The wearable computing device of claim 10, wherein the at least one processor is further configured to control the display to provide a cursor in the view region, wherein the selection data comprises cursor movement data corresponding to movement of the cursor in the view region.

16. A non-transitory computer readable medium having stored therein instructions executable by at least one processor to cause the at least one processor to perform functions comprising:
controlling a computing device to provide a user-interface, wherein the user-interface includes (i) one or more menu items and (ii) a view region that defines an area in which the one or more menu items are selectively viewable;
receiving movement data corresponding to movement of the computing device from a first position to a second position;
responsive to the movement data, controlling the computing device such that the one or more menu items are viewable in the view region;
while the one or more menu items are viewable in the view region, receiving selection data corresponding to a selection of a menu item; and
responsive to the selection data, controlling the computing device to maintain the selected menu item substantially fully viewable in the view region and in a substantially fixed position in the view region that is substantially independent of further movement of the computing device.

17. The non-transitory computer readable medium of claim 16, wherein the one or more menu items are not selectable when the computing device is at the first position.

18. The non-transitory computer readable medium of claim 16, wherein, when the computing device is at the first position, the one or more menu items are located above the view region, and wherein the movement data corresponds to a generally upward movement of the computing device to the second position.

19. The non-transitory computer readable medium of claim 16, wherein the functions further include controlling the computing device to provide a cursor in the view region, wherein the selection data comprises cursor movement data corresponding to movement of the cursor with in the view region.

20. The non-transitory computer readable medium of claim 19, wherein the selection data comprises cursor movement data corresponding to the cursor remaining substantially stationary over the selected menu item for a predetermined period of time.
